(19) United States
(12) Patent Application Publication
(10) Pub. No.: US 2025/0338990 A1
(43) Pub. Date: Nov. 6, 2025

(54) DEVICE AND METHOD FOR IMPROVING WATER DISTRIBUTION & DELIVERY FOR A SATURATED LM GROUP HEAD TYPE OF ESPRESSO MACHINE SHOWER SCREEN

(71) Applicant: Gurgen Bagdasarian, Glendale, CA (US)

(72) Inventor: Gurgen Bagdasarian, Glendale, CA (US)

(21) Appl. No.: 18/654,506

(22) Filed: May 3, 2024

(51) Int. Cl. A47J 31/44; A47J 31/34

(52) U.S. Cl. CPC A47J 31/4403; A47J 31/34

(57) ABSTRACT

An espresso water distribution system and a method and kit for dimpling an espresso machine water distribution shower screen so that a water distribution screw sit flush with a surface of the bottom face of the water distribution shower screen that surrounds a centrally disposed screw hole, thereby enhancing water distribution through a coffee bed associated with the water distribution shower screen by way of a mid-belt flow enabled by the flush fitment of the water distribution shower screen and the water distribution shower screw.

### BACKGROUND OF THE INVENTION

The present invention relates to coffee brewing systems and methods and, more particularly, to a flush fitting water distribution screw for a water distribution shower screen of a specific type of espresso machine group head (or “brew head”), whereby water distribution through the coffee bed, by way of the water distribution shower screen, is enhanced, and a method of enabling the flush fit by reforming the screw hole of the water distribution shower screen.

Espresso is a coffee-brewing method in which a small amount of nearly boiling water is forced under pressure through compacted finely ground coffee beans, typically called a coffee bed or an espresso puck. There is no universal standard defining the process of extracting espresso, but several published definitions attempt to constrain the amount and type of ground coffee used, the temperature and pressure of the water, and the rate of extraction, which in turn is a function of the properties of water distribution on and through the underlying coffee bed. With that said there are millions of espresso drinkers who are very particular about how their espresso tastes which is controlled by how exactly the espresso is made.

This water distribution is governed by the properties of a group head that directs the water from the boiler through a shower screen onto the coffee bed. For a subset of espresso machines that use the La Marzocco Saturated group head, (introduced by La Marzocco in 1970 and currently used by several espresso machine manufacturers), the shower screen is fixedly connected to the group head by a water distribution screw, with the latter performing the function of retention of the screen as well as routing the water from the group head and distrinuting it into the space above the shower screen. The water distribution screw engages the shower screen via a centrally disposed screw hole, wherein the head of the water distribution screw interfaces the bottom face of the shower screen. Problematically, however, the head of the water distribution screw protrudes beyond the surface of the bottom face of the shower screen. This protrusion can negatively impact the integrity of the coffee bed (by delving into the coffee puck) during the brew process.

Currently, for those baristas who prefer the water distribution shower screen coupled with the water distribution screw configuration, many of the preferred water distribution shower screens have a continuous bottom face so that operatively associating the water distribution screw results in the water distribution screw protruding therefrom, thus inviting the problems and negative impacts mentioned above.

As can be seen, there is a need for a flush fitting water distribution screw for a water distribution shower screen for machines that utilize this type of a brew head, whereby water distribution through the coffee bed, by way of the water distribution shower screen, is enhanced, and a method of enabling the flush fit by reforming the screw hole of the water distribution shower screen.

### SUMMARY OF THE INVENTION

The present invention may be configured as a kit that enables a user to dimple/form the bottom face of the existing/standard water distribution shower screen, thereby enabling a flush fit for the water distribution shower screen, preventing disturbed coffee bed in the espresso coffee preparation process, while enhancing water distribution through the coffee bed.

The present invention is ANCHORED AROUND a flush-fitting water distribution fitting/screw centrally disposed in a water distribution/group head shower screen, and a method that embodies a kit to reform or dimple an existing group head shower screen to accept the newly precision-machined, completely countersunk water banjo screw.

The present invention includes a method that embodies implementation of a kit that prevents the intrusion of the banjo screw head into the headspace of the espresso puck-so that the espresso puck interfaces with the flat bottom as of the shower screen as the banjo screw is countersunk therein. Thereby, the present invention allows for the use of both thick and thin puck screens and up-dosing to tight or no headspace without disturbed or damaging coffee bed through the extraction process, thereby reducing the possibility of channeling in the extraction process due to damage to the coffee puck.

The present invention incorporates a unique water distribution design to constrain water flow to the mid-belt of the shower screen, this design is governed by the water distribution screw being disposed and flush with the bottom face of the shower screen. This mid-belt water flow enables low flow rates through the espresso puck, which in turn allows for biased initial wetting during pre-infusion, thereby greatly reducing side bypass and side channeling, while allowing unconstrained flow once the group head is filled and pressurized.

The present invention may be embodied in a kit for reforming or dimpling the water distribution shower screen so that the banjo screw (specifically the drive surface of the head of the screw fitting) can form a flush engagement relative to the bottom face of the shower screen it retains, thereby allowing for a flush fit of the water distribution screw without encroaching into the coffee bed space in an espresso portafilter.

In one aspect of the present invention, an espresso group head water distribution system, the system providing the following: a group head screen having a bottom face and an opposing top face, and wherein a centrally disposed, countersunk screen hole interconnects the top and bottom faces; and a flat-headed water distribution screw engaged in the countersunk screen hole so that an upper surface of the water distribution screw is substantially flush with a surface of a portion of the bottom face surrounding the countersunk screen hole, whereby a mid-belt flow when pressurized water is urged through the group head screen.

In another aspect of the present invention, a method of dimpling group head screen of the espresso group head water distribution system includes the following: urging a tapered root of a fastener head against a portion of a bottom face surrounding a centrally disposed screen hole of the group head screen until a dimple is formed therein; after seating a portion of a top face surrounding the centrally disposed screen hole on a forming die so that a countersunk hole of the forming die aligns with the centrally disposed screen hole.

In yet another aspect of the present invention, a kit for forming a dimple in a continuous curved face of an espresso group head screen for enabling the above-mentioned system includes the following: a forming die having a countersunk hole; a forming screw having a tapered head; and the water distribution screw.

These and other features, aspects and advantages of the present invention will become better understood with reference to the following drawings, description, and claims.

### BRIEF DESCRIPTION OF THE DRAWINGS

FIG. 1A is a perspective view of an exemplary embodiment of the present invention in the form of a kit 100.

FIG. 1B is a perspective view of an exemplary embodiment of the present invention, illustrating an initial step of dimpling or reforming method in one aspect of the present invention.

FIG. 2 is a section view of an exemplary embodiment of the present invention, taken along line 2-2 in FIG. 1B.

FIG. 3 is a detailed section view of an exemplary embodiment of the present invention, illustrating forming screw engagement between the forming screw 14 and the bottom face 26 of the water distribution shower screen or group head screen 10, wherein by successive tightening of the forming screw 14 further dimples said bottom face 26.

FIG. 4 is a detailed section view of an exemplary embodiment of the present invention, illustrating forming screw disengagement.

FIG. 5 is an exploded bottom perspective view of an exemplary embodiment of the present invention, illustrating the operative association of the water distribution screw 16 with the group head screen 10 by nesting the head of the banjo screw 16 into the dimple 21 of the reformed screen hole 22.

FIG. 6 is a bottom perspective view of an exemplary embodiment of the present invention, illustrating installation of the water distribution system.

FIG. 7 is a section view of an exemplary embodiment of the present invention, taken along line 6-6 in FIG. 7.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

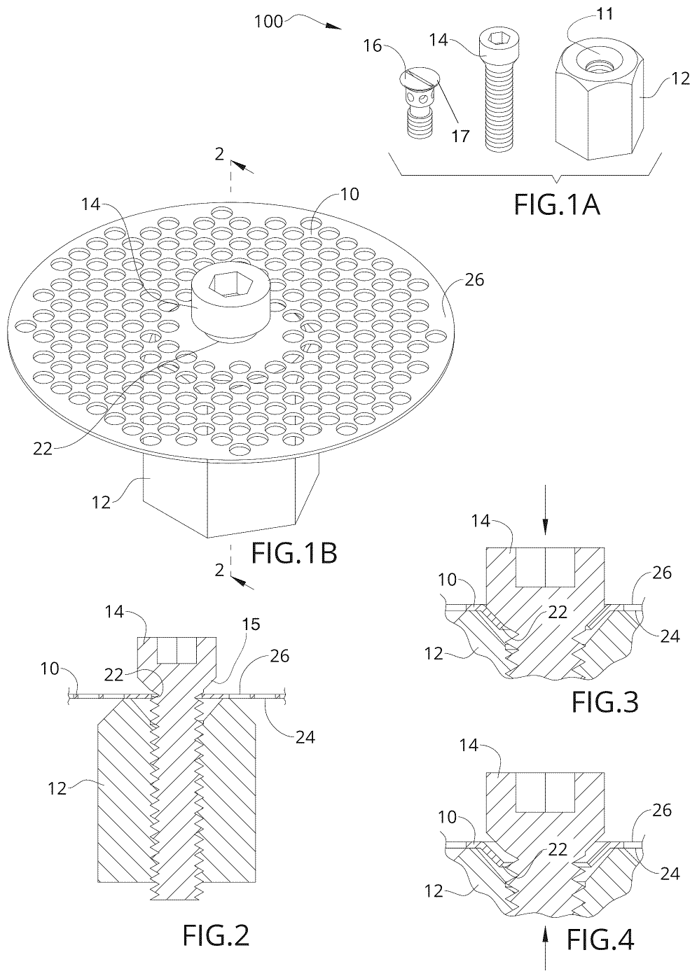

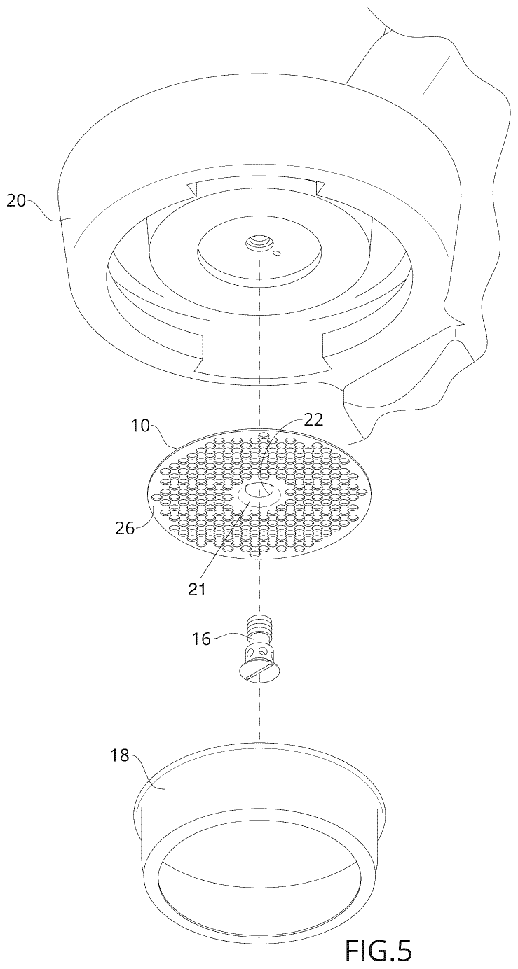

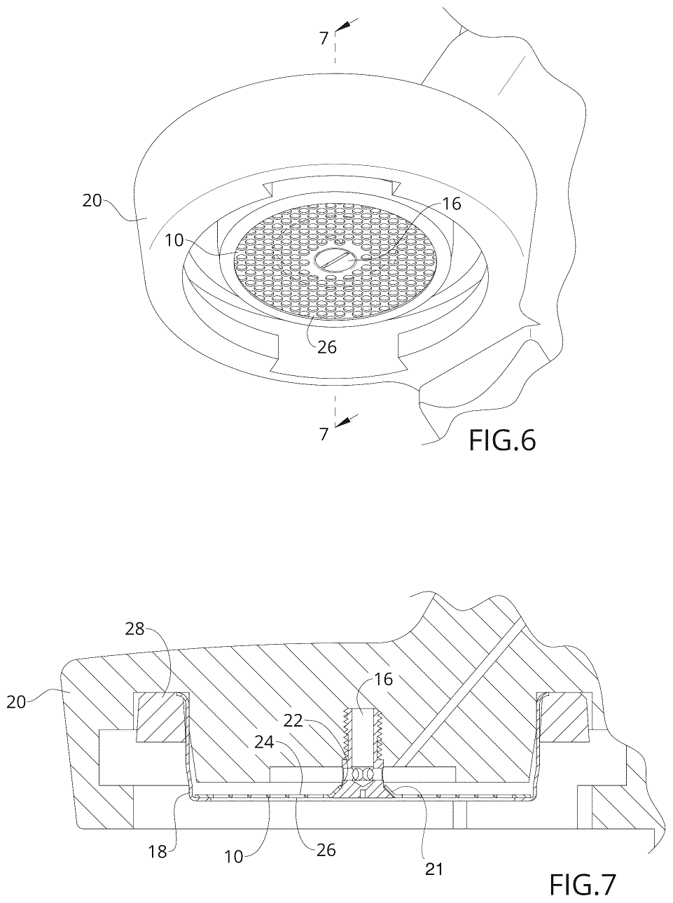

Referring to FIGS. 1 through 7, the present invention may include a kit 100 for reforming an espresso machine water distribution shower screen (also known as group head screen 10) and water distribution screw (also known as banjo screw 16) for a flush fitment therebetween, thereby enhancing water distribution through the group head screen 10 and into the coffee bed/espresso puck (not shown). The screw 16 is uniquely and totally flat-headed and flat with the plane of the bottom of the shower screen as compared to standard water distribution fittings in use for these LM Saturated Head shower screens screws. Specifically, the non-threaded portion of the screw 16 is precision machined to fit into the newly formed hole diameter and have minimally extending, precisely angled circumferential notch/shoulder to retain the shower screen in place with each of the mating surfaces of the screw 16 head and head taper fitting flatly against the taper of the formed shower screen 10.

The kit 100 may include a forming die 12, a forming screw 14, and a banjo screw 16. The forming die 12 may be made from 12L14 carbon steel or equivalent material that enables the functionality disclosed herein. The forming die 12 may be countersunk with a recess 11. The forming screw 14 may be a forming/countersink machine screw (e.g., Zinc-Plated Alloy Steel Hex Drive ¼″-20 Thread Size, 1″ Long, American inch screws {UNC, UNF, UNS} with a normal countersunk angle or approximately 82 percent, or equivalent material and size that enables the functionality disclosed herein). The banjo screw 16 is a diffusion screw made of 316 Stainless Steel, M6×1.0 mm, or equivalent material and size that enables the functionality disclosed herein.

The kit 100 may provide a hex L-key (made of black oxide steel, or equivalent material) that enables the driving the forming screw during the initial reforming or dimpling process.

The kit 100 enables the process of reforming a flat group head screen 10, thereby dimpling its group head screen screw hole 22 so that a countersunk banjo/distribution screw 16 may be countersunk in said hole 22 for a flush fit. The flush fitment enabling the advantages of the water distribution system of the present invention during the extraction process without the distribution screw protruding downward beyond the group head shower screen 10, which otherwise protrude into the coffee puck space and fail to provide an optimal mid-belt flow of water distribution.

The reforming or dimpling process if enabled through the group head screen along the periphery of the screen hole 22 being sandwiched between the countersunk recess of the forming die 12 and the selectively movable countersunk body of the head of the forming screw 14 during an engagement process illustrated in FIG. 3.

The design of the kit tools is machined to high tolerances for clean fitment so that the forming screw 14 and the forming die 12 reform the screen 10—i.e., dimpled the screen hole 11—to accept the banjo screw 16 with minimal effort.

A method of using the present invention may include the following steps. A user unscrews the forming screw 14 from the forming die 12 (if the two are not already separated). Using a bench vise, a large box wrench (19 mm, or ¾″) or the like, the user holds the forming die 12 in place with its countersink recess 11 receiving side facing upwards.

Then the user places the forming screw 14 through the group head screen 10, by way of the group head screen hole 22 so that the bottom face 26 of the group head screen 10 is facing up. Specifically, the head 15 of the forming screw 14 is above the group head screen screw bottom face 26, while the forming die 12 engages the group head screen screw top face 24, as illustrated in FIG. 1A through FIG. 4. The user then selectively screws the forming screw 14 into the female threads forming die 12 by hand until the forming screw 14 snugs up against the group head screen 10 and then compresses the area of the group head screen 10 immediately circumscribing the group head screen hole 22 until a satisfactory dimple 21 is formed around the group head hole 22.

Then the user may insert the Allen key onto the forming screw 14 head 15. Note that the steps that follow need to be performed carefully and in stepwise, methodical fashion. Turning the Allen key urges the forming screw 14 to deform the group head screen 10 and form the desired countersink/dimple 21 into the group head screen 10 about the group head hole 22. The objective is to match the countersink to the head 17 of the diffuser screw 16, using a spare screen if possible.

Because there are both thin as well as thick group head screen 10 available on the market, the size and exact shape of the countersink space (on the forming die 12) was designed to be universal and accommodate the thicker La Marzocco/E&B Labs screens as well the thinner Slayer/IMS screens. Additionally, the amount of force required to bend the metal of the screen is different for each.

Approximate degrees or rotation of the Allen wrench or equivalent tool translates into the applied force (discussed above) by which a user needs to turn the forming screw 14 to achieve the desired form varies depending on the group head screen 10 size. For this reason, the thinner screen will require much less force and travel (as described below) then the “full turn until it stops” technique of turning of the forming screw 14 into the group head screw hole 22. To be safe, start by turning the forming screw 14 approximately 120°; removing the forming screw 14 and the group head screen 10; and test the fitment of the banjo/diffuser screw 16 in the counter sink.

Fitment is determined by assembling the group head screen basket 18, a group head gasket 28, and the group head screen 10 to the group head 20 by way of the banjo/diffuser screw 16, as illustrated in FIGS. 5-7. If the head 17 of the diffuser screw 16 is not completely flush with the surface, start over and re-insert the forming screw 14 and further bend the group head screen 10 by turning the Allen key/screw additional 30-45° at a time, testing the fitment at each trial, until the desired depth is achieved. The user is mindful that during use, group head screen 10 has its group head screen screw bottom face 26 engaging the head 17 of the banjo/diffuser screw 16, while the group head screen screw top face 24 faces upward toward the body of the group head 20.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

1. An espresso group head water distribution system, the system comprising:
a group head screen having a bottom face and an opposing top face, and wherein a centrally disposed, countersunk screen hole interconnects the top and bottom faces, wherein the countersunk screen hole has a countersunk angle of approximately eighty-two degrees; and
a flat-headed water distribution screw engaged in the countersunk screen hole so that an upper surface of the water distribution screw is flush with a surface of a portion of the bottom face surrounding the countersunk screen hole, whereby a mid-belt flow when pressurized water is urged through the group head screen.

2. A method of dimpling group head screen of the espresso group head water distribution system of claim 1, the method comprising:
urging a tapered root of a fastener head against a portion of a bottom face surrounding a centrally disposed screen hole of the group head screen until a dimple is formed therein, wherein the dimple has a countersunk angle of approximately eighty-two degrees,
whereby, when the flat-headed water distribution screw is engaged in the dimple, the upper surface of the water distribution screw is flush with the surface of a portion of the bottom face surrounding the dimple.

3. The method of claim 2, further comprising seating a portion of a top face surrounding the centrally disposed screen hole on a forming die so that a countersunk hole of the forming die aligns with the centrally disposed screen hole.

4. A kit for forming a dimple in a continuous curved face of an espresso group head screen for enabling the system of claim 1, the kit comprising:
a forming die having a countersunk hole having a countersunk angle of approximately eighty-two degrees;
a forming screw having a tapered head; and
the water distribution screw.
